(19) United States
(12) Patent Application Publication
(10) Pub. No.: US 2023/0214451 A1
(43) Pub. Date: Jul. 6, 2023

(54) SYSTEM AND METHOD FOR FINDING DATA ENRICHMENTS FOR DATASETS

(71) Applicant: Explorium Ltd, Tel Aviv (IL)

(72) Inventors: Anthony TRABAUD, Tel Aviv (IL); Revital RUBIN COHN, New York, NY (US); Shai YANOVSKI, Tel Aviv (IL); Omer HAR, Tel Aviv (IL); Tamir OR, Foster City, CA (US); Maor Ziv SHLOMO, Tel Aviv (IL)

(73) Assignee: Explorium Ltd, Tel Aviv (IL)

(21) Appl. No.: 17/565,869

(22) Filed: Dec. 30, 2021

(51) Int. Cl. G06K 9/62; G06N 3/04

(52) U.S. Cl. CPC G06K 9/6257; G06N 3/0454; G06K 9/6228

(57) ABSTRACT

A computer-based system and method for finding data enrichments for a first dataset, including obtaining a plurality of candidate datasets; calculating a plurality of mathematical representations, each for one of the first dataset and one of the plurality of candidate datasets, wherein calculating the mathematical representation of a dataset of the first dataset and the plurality of candidate datasets comprises: calculating a set of features of the dataset; and feeding the set of features of the dataset to a first neural network trained to generate the mathematical representation; calculating a plurality of similarity levels, each indicative of the similarity between the mathematical representation of one of the plurality of candidate datasets and the mathematical representation of the first dataset; and selecting the candidate dataset based on the similarity levels.

### FIELD OF THE INVENTION

The present invention relates generally to generating dataset embeddings. More specifically, the present invention relates to generating dataset embedding in order to find enrichments for datasets.

### BACKGROUND

Training machine learning (ML) models requires a large number of samples. Developers of ML models for images may use huge readymade collections of labeled images to train their ML models. Developers of ML models for datasets, however, may encounter a problem of insufficient data samples. Thus, a method for enriching datasets is required.

### SUMMARY

According to embodiments of the invention, a system and method for finding data enrichments for a first dataset may include, using a processor: obtaining a plurality of candidate datasets; calculating a plurality of mathematical representations, each for one of the first dataset and one of the plurality of candidate datasets, where calculating the mathematical representation of a dataset of the first dataset and the plurality of candidate datasets may include: calculating a set of features of the dataset and feeding the set of features of the dataset to a first neural network trained to generate the mathematical representation; calculating a plurality of similarity levels, each indicative of the similarity between the mathematical representation of one of the plurality of candidate datasets and the mathematical representation of the first dataset; and selecting the candidate dataset based on the similarity levels.

According to embodiments of the invention, calculating the set of features for each dataset may include: calculating column interaction features, where the column interaction features may be features related to interactions between different columns of data from the plurality of columns of data; calculating features related to statistics of a column of data from the plurality of columns of data; and predicting an ontology of a column of data from the plurality of columns of data.

According to embodiments of the invention, generating column interaction features for a pair of columns of data may include: inferring pairs of data items from different columns using a second neural network to generate inferred values; and providing the inferred values into a pooling layer.

According to embodiments of the invention, training the first neural network may include: using labeled pairs of sets of features to train a Siamese neural network, wherein a label of a pair indicates whether the two sets of features in the pair pertain to a same dataset.

Embodiments of the invention may include generating the labeled pairs of sets of features by: obtaining a first labeled pair of datasets; selecting a subset of each dataset of the pair of datasets to generate a second labeled pair of datasets; and calculating the set of features for each dataset of the second pair of datasets.

Embodiments of the invention may include updating a current mathematical representation of a first candidate dataset of at least one of the plurality of candidate datasets by: obtaining new data pertaining to the first candidate dataset; generating a new mathematical representation for the new data; and combining the new mathematical representation with the current mathematical representation.

According to embodiments of the invention, combining the new mathematical representation with the current mathematical representation may be performed using weighted average with an exponential decay factor.

Embodiments of the invention may include using the selected candidate dataset to enrich the first dataset, where enriching the first dataset with the selected candidate dataset may include combining the first dataset with the selected candidate dataset.

According to embodiments of the invention, each of the first dataset and the candidate datasets may include a time series.

According to embodiments of the invention, calculating the level of similarity between the first dataset and a candidate dataset may include one of: calculating Euclidean distance between the mathematical representation of the first dataset and the mathematical representation of the candidate dataset, calculating cosine similarity between the mathematical representation of the first dataset and the mathematical representation of the candidate dataset, or training a second machine learning model to calculate the level of similarity using labeled pairs of mathematical representations and feeding the mathematical representations of the first dataset and the mathematical representation of the candidate dataset to the trained second machine learning model to calculate the level of similarity.

### BRIEF DESCRIPTION OF THE DRAWINGS

The subject matter regarded as the invention is particularly pointed out and distinctly claimed in the concluding portion of the specification. Embodiments of the invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a flowchart of a method for generating a mathematical representation of a dataset, according to embodiments of the invention;

FIG. 2 is a flowchart of a method for extracting features of a dataset, according to embodiments of the invention;

FIG. 3 is a flowchart of a method for training a Siamese neural network, according to embodiments of the invention;

FIG. 4 is a flowchart of a preparation phase of a method for finding enrichments for datasets, according to embodiments of the invention;

FIG. 5 is a flowchart of a method for finding enrichments for datasets, according to embodiments of the invention;

FIG. 6 is a flowchart of a method for updating an embedding of a dataset, according to embodiments of the invention;

FIG. 7 is a flowchart of a method for training an ML model for datasets, according to embodiments of the invention; and

FIG. 8 is a schematic illustration of an exemplary computing device, which may be used with embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Although some embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device that manipulates and/or transforms data represented as physical (e.g., electronic) quantities within the computer's registers and/or memories into other data similarly represented as physical quantities within the computer's registers and/or memories or other information transitory or non-transitory or processor-readable storage medium that may store instructions, which when executed by the processor, cause the processor to execute operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items unless otherwise stated. Unless explicitly stated, the method embodiments described herein are not constrained to a particular order or sequence. Additionally, some of the described method embodiments or elements thereof can occur or be performed in a different order from that described, simultaneously, at the same point in time, or concurrently.

Embodiments of the invention may provide data enrichments for datasets. For example, datasets available on the world wide web may be selected and used to enrich a given dataset. For example, for generating an ML model, the ML model may be trained and tested using available datasets. Testing the model may include calculating accuracy metrices such as precision and recall on labeled datasets. If, for example, the precision and/or recall values are not good enough, then further training may be required. However, if all available datasets were already used for training and testing, then enrichment may be required. The enriched dataset may be used, for example, to further train an ML model or for other purposes. Embodiments of the invention may obtain a dataset for which an enrichment is required, calculate a similarity level between the obtained dataset and a plurality of candidate datasets, e.g., privately owned datasets, datasets from various providers, datasets that are available on the world wide web, etc., and recommend which datasets from the candidate datasets may be used as enrichments. Embodiments of the invention may improve the technology of ML models for datasets. Embodiments of the invention may provide enrichments for datasets, that may enable better training of ML models for datasets. Better training may provide more accurate ML models for datasets, compared to prior art.

A dataset may include organized data stored in a computerized system. For example, a dataset may include data items arranged logically as an array or a table of rows and columns. A row in a dataset may relate to a single entity and each column in the dataset may store an attribute associated with the entity. A column may include data items that pertain to a single data category or data type, also referred to as ontology. Data categories may include a company stock price, weather forecast for London, dates, names, etc. Data items may be alphabetical, alphanumeric, numerical, and/or other standard formats. Data items in a column of a dataset may include a time series, e.g., samples taken over time, e.g., a column of a company stock price may include the company stock prices over time.

Embodiments of the invention may provide a method for calculating a mathematical representation, also referred to as an embedding, of a dataset. It is very common in ML, and more specifically in deep learning, to build mathematical representations or embeddings for different types of objects. For example, in computer vision, embeddings are built and used to classify images. Similarly, mathematical representations are commonly used in natural language processing (NLP) in order to capture the sentiment and context of a sentence. A mathematical representation or embedding may include a list of numbers or values that may capture relevant information of the given object.

However, providing a mathematical representation for a dataset presents domain specific challenges. As will be explained in detail herein, datasets are different in nature from images or audio. Therefore, simply implementing methods used for images or audio of data to datasets to generate an embedding may provide meaningless results. Other challenges include insufficient samples for training.

In many deep learning applications, convolution and pooling layers are inserted prior to the fully connected layers, in order to, for example, reduce the dimension of the data to a fixed length vector. For example, convolution and pooling can be used to perform dimensionality reduction for images, e.g., to capture the essence of an image whilst reducing its dimensions to a fixed length vector. However, convolution and pooling can highly depend on inter relation between adjacent pixels in an image. Such interrelations typically do not exist in the same manner between items of a dataset (e.g., that is not an image). Therefore, performing convolution and pooling on data items of a dataset can be meaningless. Thus, convolution and pooling can be unsuitable for reducing the dimensionality of a dataset whilst preserving its essence.

Many ML models can require a predefined input shape, e.g., a predefined image size. For processing data that is an image, this requirement can be addressed by modifying an image size and pixel density, typically without negatively impacting the resulting representation; e.g., a picture of a cat can be dimensionally large or small and can be expanded or compressed, up to a certain extent, without losing the information that allows the image to be interpreted as that specific cat. In the case of a dataset, where each column may be key to the representation of that dataset, there may be no way of directly removing or adding columns to fit a standard shape without either losing information or adding noise.

Embodiments of the invention may provide a system and method for generating a mathematical representation or embedding of a dataset, e.g., for capturing the essence of a dataset whilst allowing this information to be preserved during dimensionality reduction. Embodiments of the invention may not require any special preparations or standardization of the dataset, and may provide dimensionality reduction to practically any size of tabular dataset.

Furthermore, training sets for ML models for images may be easily generated using huge collections of labeled images that are widely available, e.g., on the world wide web or elsewhere. In contrast, only a few hundred un-labeled datasets are available for training ML models for datasets. Embodiments of the invention may also address this dataset sparsity problem. According to embodiments of the invention, subsampling may be used to generate a plurality of labeled datasets for training from a single dataset.

According to embodiments of the invention, the mathematical representation or embedding of datasets may be used for ranking datasets and for recommending enrichments for datasets. A dataset may include either static data or a data flow. For example, static data may include names of regions and their postal code in a specific country and a data flow may include a daily report about the weather in multiple areas.

Embodiments of the invention may improve the technology of ML, and particularly the technology of ML models for datasets, by providing mathematical representations or embeddings for datasets, and by providing recommendations for data enrichments for datasets.

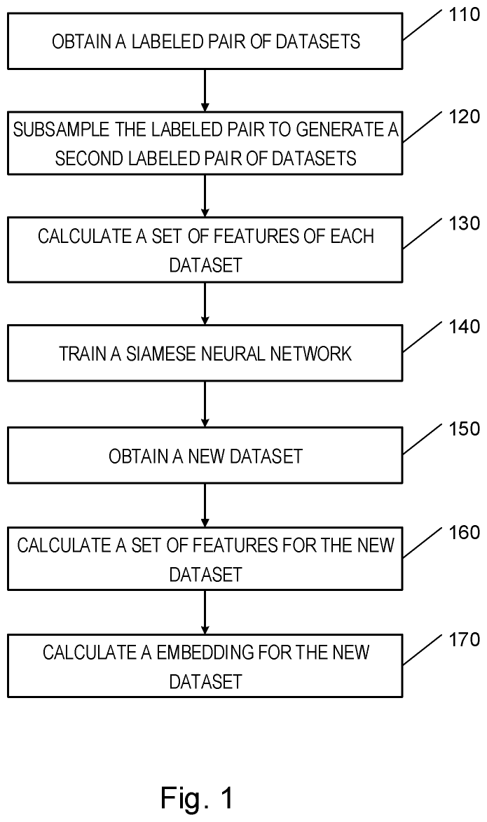

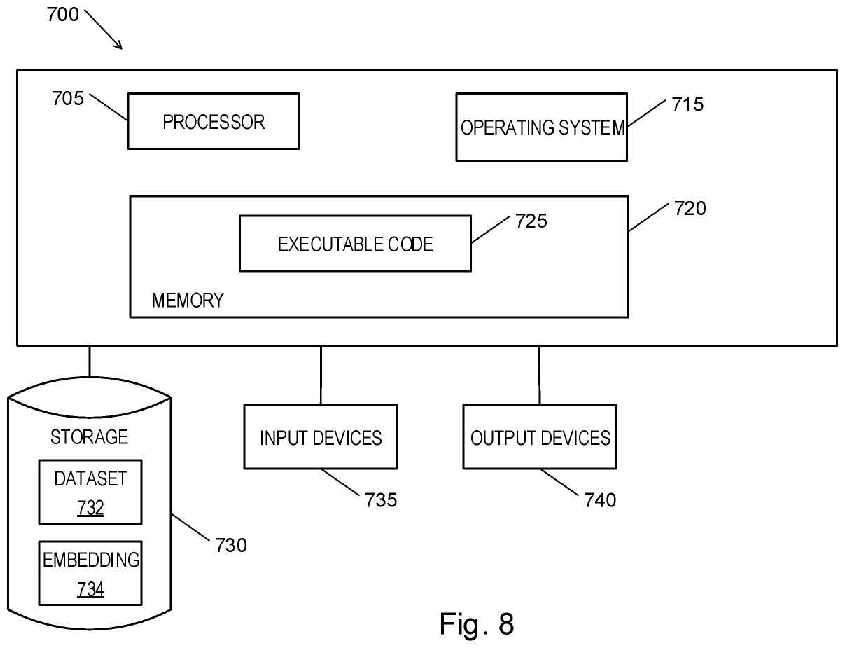

Reference is made to FIG. 1, which is a flowchart of a method for generating a mathematical representation (also referred to as an embedding) of a dataset, according to embodiments of the invention. An embodiment of a method for generating a mathematical representation or an embedding of a dataset may be performed, for example, by the systems shown in FIG. 8, or alternatively by another system.

In operation 110, a processor (e.g., processor 705 depicted in FIG. 8), may obtain one or more labeled pairs of datasets. The label may indicate whether the datasets are similar, related, or pertain to a same type of dataset e.g., whether those datasets may be used as an enrichment for one another. The pairs of datasets may be labeled manually by a human operator, automatically or semi automatically.

The labeled pairs of datasets may be used to train an ML model to detect datasets for enrichments. As noted, the number of labeled pairs of datasets that are available may not be sufficient for proper training of ML models. In some embodiments, thousands up to millions of samples are required for training an ML model up to production level, while only a few hundreds labeled pairs are available (e.g., in the world wide web or from other sources). Therefore, in operation 120, new pairs of labeled datasets may be generated from a single dataset or from the pairs of datasets obtained in operation 110, e.g., using subsampling. According to embodiments of the invention, subsampling may be an effective method for generating the large number of pairs of datasets required to train Siamese NN 230, e.g., at least thousands of subsamples.

For example, a subset of each dataset of the pair of datasets may be selected to generate a second labeled pair of datasets. For example, a subset of rows may be selected randomly from the first dataset of the labeled pair of datasets to form or create a first dataset in a new pair of datasets. A second subset of rows may be selected randomly from the second dataset of the labeled pair of datasets to form or create a second dataset in a new pair of datasets. The label of the new pair of datasets may be identical to the original labeled pair of datasets. This process may be repeated on one or more labeled datasets to generate the required number of labeled pairs of datasets. In some embodiments, similar or related datasets are generated by subsampling a single dataset. For example, a subset of rows may be selected randomly from the dataset to form or create a first dataset in a new pair of datasets. A second subset of rows may be selected randomly from the same dataset to form or create a second dataset in the new pair of datasets. The label of the new pair of datasets may indicate that the two datasets in the pair are related.

In some embodiments, sub sampling includes selecting a subset of columns in addition or instead of selecting a subsample of rows. For example, subsampling may include selecting 2\hat{ }n rows where n is a number between 5-10 selected randomly, and selecting k columns where k is a number between 2-8, shuffling the rows and shuffling the columns. Other protocols may be used for subsampling, e.g., using other values of n and k, using other distribution function for subsampling, etc.

In some embodiments, a subsampling protocol includes obtaining a first dataset and randomly selecting a label, e.g., similar or not similar. If the label is similar, the first dataset can be subsampled twice to generate a pair of datasets that are labeled as similar. If the label is not similar, a second dataset, that is not similar to the first dataset can be obtained, the first dataset can be subsampled to generate the first dataset of a pair of datasets and the second dataset can be subsampled to generate the second dataset for the pair. The label of the pair can be not similar.

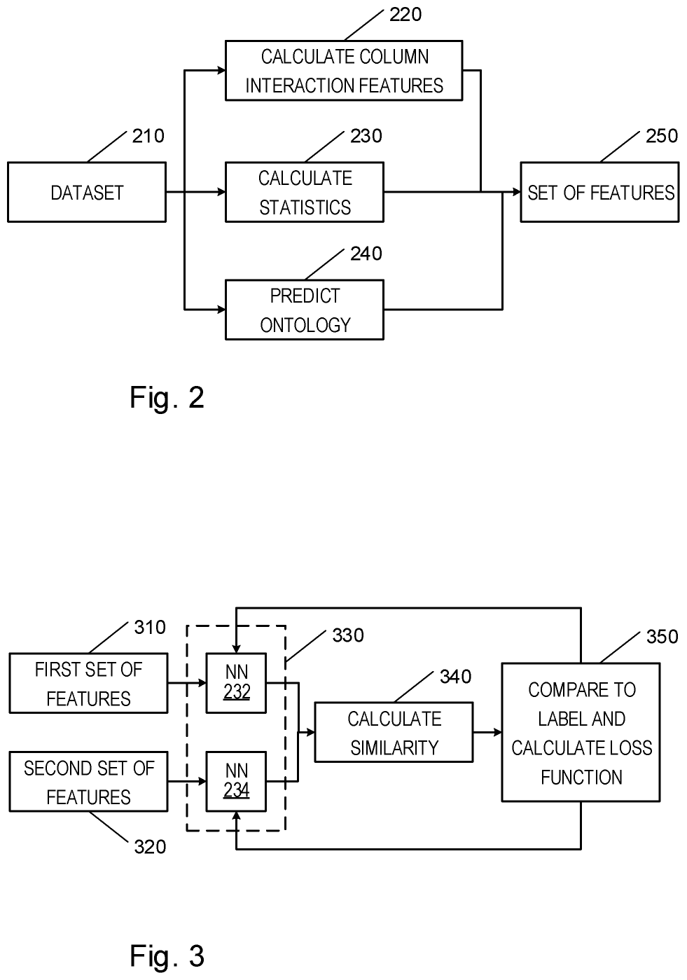

In operation 130, the processor may calculate a set of features for each dataset, e.g., a set of features for each dataset of the labeled pair of datasets. The features may include column interaction features, column statistics and ontology of columns, as disclosed herein e.g., with relation to operations 220-240 in FIG. 2. Thus, each labeled pair of datasets may be represented by a labeled pair of sets of features. In operation 140 the labeled pairs of sets of features may be used for training a Siamese neural network (NN) to generate a mathematical representation or embedding of a dataset, as disclosed herein.

Operations 110-140 may include the training phase of a NN. According to embodiments of the invention, the NN trained in operation 140 may be configured to obtain a feature set of a new dataset, and to generate a mathematical representation or embedding of the new dataset. The mathematical representation or embedding may provide dimension reduction of the original dataset, or a condense representation of the original dataset. The mathematical representation or embedding may be seen as characterizing the dataset and may be used for identifying the differences and similarities between two datasets. For example, given a dataset A including stock price of a company and a dataset B including weather forecast for London, the mathematical representation should capture that the subjects of the datasets are different but both include a time series.

Operations 150-170 may include the inference stage. In operation 150, the processor may obtain a new dataset. In operation 160, the processor may calculate a set of features for the new dataset, e.g., similarly to operation 130. In operation 170, the processor may calculate a mathematical representation or embedding for the new dataset by providing the set of features of the new dataset to the NN trained in operation 140. The NN, operated by the processor, may obtain the set of features of the new dataset as input, and provide the mathematical representation or embedding of the new dataset as output.

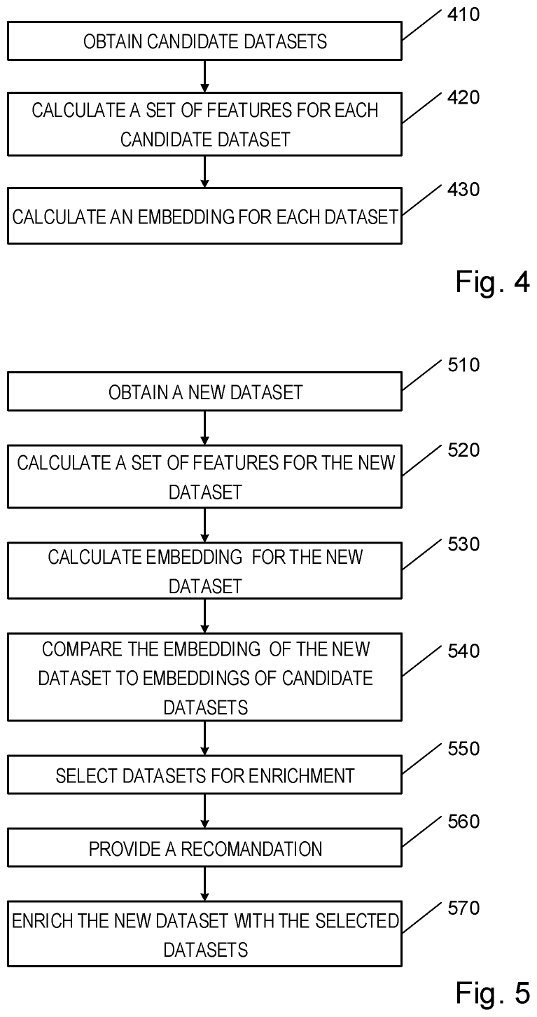

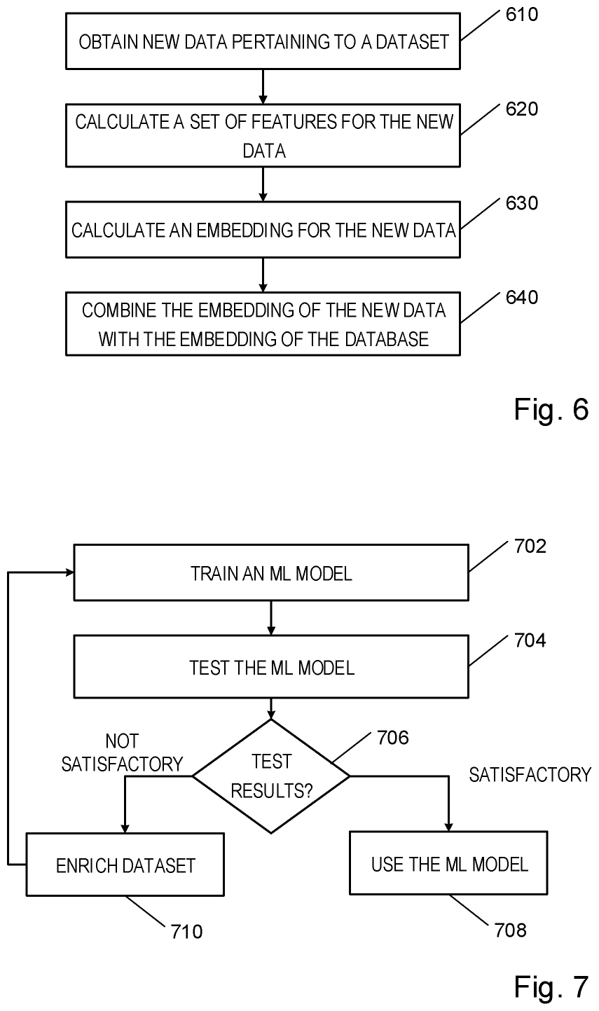

Reference is made to FIG. 2, which is a flowchart of a method for calculating a set of features for a dataset, according to embodiments of the invention. An embodiment of a method for calculating a set of features for a dataset may be performed, for example, by the systems shown in FIG. 8, or alternatively by another system. Embodiments of the method for calculating a set of features for a dataset may be an elaboration of operations 130 and 160 in FIG. 1, operation 420 in FIG. 4, operation 520 in FIG. 5 and operation 620 in FIG. 6.

In operation 210, a dataset may be provided to a processor. In operations 220-240 the processor may calculate or extract a set of features for the dataset. In operation 220 the processor may perform bivariate analysis to calculate or extract features related to empirical relationships or interactions between columns of data in the dataset, also referred to herein as column interaction features. For example, the processor may extract pairs of data items from different columns and use a dedicated NN trained for this purpose (a different NN than the one that is trained in operation 140) to infer the relationship between the two data items. The results of the inference may be provided to a pooling layer that may provide the column interaction features. Other methods for calculating or extracting features related to relationships or interactions between columns in the dataset may be used, e.g., using other ML models or statistical methods as correlations, linear regressions, etc.

In operation 230 the processor may perform univariate analysis to calculate or extract features related to statistics of a column of data. The statistics of a column of data may include, for example an average number of characters of data items in a column, the average value of data items in a column, the variance, standard deviation, median, etc. In some embodiments different statistics is used for numbers or strings. In typical applications, about 500-2000 features related to statistics of a column of data may be calculated per column.

In operation 240 the processor may predict, estimate or determine an ontology, e.g., a type or category, of a column of data. The ontology may be estimated based on the statistical features extracted in operation 230. In some embodiments, the ontology is provided in the header of the column, or information provided in the header may be used for determining the ontology. In operation 250, the column interaction features calculated in operation 220, the features related to statistics of columns of data extracted (for various columns in the dataset) in operation 230, and the ontology determined in operation 240 may be unified to provide the set of features of the dataset obtained in operation 210.

Reference is made to FIG. 3, which is a flowchart of a method for training a Siamese NN, according to embodiments of the invention. An embodiment of a method for training a Siamese NN may be performed, for example, by the systems shown in FIG. 8, or alternatively by another system. Embodiments of the method for training a Siamese NN may be an elaboration of operation 140 of FIG. 1.

In operation 310, a first set of features may be obtained. The first set of features may be extracted or calculated from a first dataset of a pair of datasets as disclosed herein. In operation 320, a second set of features may be obtained. The second set of features may be extracted or calculated from a second dataset of a pair of datasets as disclosed herein. The first set of features and the second set of features may be provided to a Siamese NN 230. Siamese NN 230 may include two identical NN networks, NN 232 and NN 234, such that the first set of features may be provided as input to NN 232 and the second set of features may be provided as input to NN 234. Each of NN 232 and NN 234 may provide a prediction as an output and in operation 340, the predictions of NN 232 and NN 234 may be compared to calculate a similarity measure (or similarity level) using any applicable method such as Euclidean distance, Manhattan distance, Minkowski distance, cosine similarity, an ML model etc. The similarity level or measure may be indicative of the similarity or distance between the compared datasets. A threshold may be used to determine, based on the similarity measure, whether Siamese NN 230 has predicted that the two datasets are similar or not. Thus, the result of operation 340 may be a similarity prediction, where a first value, e.g., ‘1’, may indicate that Siamese NN 230 has predicted that the two datasets are similar and a second value, e.g., ‘0’ may indicate that Siamese NN 230 has predicted that the two datasets are different. In operation 350, the processor may compare the prediction of Siamese NN 230 to the label of the pair of datasets (the dataset of which sets of features are obtained in operations 310 and 320). Further in operation 350, the processor may calculate a loss function using the results of the calculation, and adjust the weights of Siamese NN 230, e.g., of NN 232 and NN 234.

Reference is made to FIG. 4, which is a flowchart of a preparation phase of a method for finding enrichments for datasets, according to embodiments of the invention. An embodiment of a preparation phase of a method for finding enrichments for datasets may be performed, for example, by the systems shown in FIG. 8, or alternatively by another system. In the preparation phase, a mathematical representation or embedding may be generated to each of a plurality of candidate datasets. The embeddings may later be used to find among the plurality of candidate datasets, datasets that are similar to a new dataset. The preparation phase may be repeated whenever one or more new candidate datasets are obtained.

In operation 410, at least one candidate dataset can be obtained by a processor. In operation 420, the processor may calculate a set of features for each of the candidate datasets as disclosed herein, e.g., as described with reference to FIG. 2. In operation 430, the processor may calculate an embedding or a mathematical representation for each of the candidate datasets, e.g., by providing the set of features to a NN trained (e.g., in operation 140) to generate the embedding, e.g., to NN 232 or NN 234 trained as disclosed herein.

Reference is made to FIG. 5, which is a flowchart of a method for finding enrichments for datasets, according to embodiments of the invention. An embodiment of a method for finding enrichments for datasets may be performed, for example, by the systems shown in FIG. 8, or alternatively by another system.

In operation 510, the processor may obtain a new dataset, and a request to enrich the dataset. In operation 520, the processor may calculate a set of features for the new dataset as disclosed herein, e.g., as described with reference to FIG. 2. In operation 530, the processor may calculate an embedding or a mathematical representation for the new dataset, e.g., by providing the set of features of the new dataset to the NN trained (e.g., in operation 140) to generate the embedding, e.g., to NN 232 or NN 234 trained as disclosed herein. In operation 550, the processor may select, from the plurality of candidate datasets, datasets that are similar to the new dataset and are therefore suitable for enriching the new dataset. For example, the processor may calculate a similarity measure between the embedding of the new dataset and the embedding of each of the candidate dataset (or some of the candidate datasets) and select the candidate datasets that are similar to the new dataset, e.g., the candidate datasets with the highest similarity measure, or the candidate datasets with a similarity measure that satisfies a threshold. In operation 560, the processor may provide a recommendation, e.g., to a user. For example, the processor may recommend using the datasets selected in operation 550 as enrichments for the new dataset. In operation 570, the processor may use the selected candidate dataset to enrich the new dataset, e.g., by combining the new dataset with the selected candidate dataset. For example, combining may include appending the selected dataset to the new dataset.

Reference is made to FIG. 6, which is a flowchart of a method for updating an embedding of a dataset, according to embodiments of the invention. An embodiment of a method for updating an embedding of a dataset may be performed, for example, by the systems shown in FIG. 8, or alternatively by another system. As noted herein, some datasets may include a data flow, e.g., data may be added regularly to those datasets. For example, in a dataset of a company stock prices, new data may be obtained every day to reflect daily changes, every week to reflect weekly changes, etc. Calculating embedding for large datasets whenever new data is added may be a computationally intensive task. In addition, it may be desired in some applications to give more weight to new data relatively to old data in the dataset. Embodiments of the invention may provide an efficient method for calculating the mathematical representation or embedding of a dataset that would account for new data added to the dataset. Embodiments of the invention may provide an efficient method for giving more weight to new data relatively to old data when updating the mathematical representation or embedding of the dataset to account for the new data.

In operation 610, the processor may obtain new data pertaining to a dataset (e.g., to a candidate dataset). In operation 620 a set of features may be calculated for the new data only, using embodiments of the method for calculating a set of features for a dataset disclosed herein, e.g., as described with reference to FIG. 2. In operation 630, the processor may calculate an embedding or a mathematical representation for the new data only, e.g., by providing the set of features of the new data to the NN trained to generate the embedding, e.g., to NN 232 or NN 234 trained as disclosed herein. In operation 640 the processor may combine or unify the embedding of the new data with the embedding of the dataset, e.g., the embedding that was calculated for the dataset before the new data was added to the dataset. According to some embodiments, combining the mathematical representation or embedding of the new data with the mathematical representation or embedding of the dataset may be performed using weighted average, optionally with a decay factor. The decay factor may provide more weight to newer data compared to the older data, and may be linear, exponential etc.

Reference is made to FIG. 7, which is a flowchart of a method for training an ML model for datasets, according to embodiments of the invention. An embodiment of a method for training an ML model for datasets may be performed, for example, by the systems shown in FIG. 8, or alternatively by another system.

In operation 702 the ML model may be trained, e.g., by a processor, using available labeled datasets, e.g., privately owned datasets, datasets available from the world wide web or from other sources. In operation 704, the trained ML model may be tested against labeled datasets, the same or different datasets used in operation 702. For example, accuracy metrices such as precision and recall may be calculated. In operation 704, the quality may be assessed, e.g., by comparing the accuracy metrices to one or more thresholds. If the quality of the trained ML model is satisfactory, e.g., if the accuracy metrices satisfy the thresholds, then the ML model may be used for its intended purpose, as indicated in operation 708. If, however, the quality of the trained ML model is not satisfactory, e.g., if the accuracy metrices do not satisfy the thresholds, then the datasets used for training the model may be enriched, as indicated in operation 710. For example, the datasets used for training the model may be enriched using embodiments of the method for finding enrichments for datasets disclosed herein with reference to FIG. 5. After the datasets are enriched, the ML model may be further trained and tested, and so forth, until a satisfactory quality is achieved or until other criteria is met. Embodiments of the invention may improve the technology of ML, by providing more accurate ML models for datasets.

FIG. 8 is a schematic illustration of an exemplary computing device, which may be used with embodiments of the present invention. Computing device 700 may include a processor 705 that may be, for example, a central processing unit processor (CPU), a chip or any suitable computing or computational device, an operating system 715, a memory 720, storage 730, input devices 735 and output devices 740. Processor 705 may be or include one or more processors, etc., co-located or distributed. Computing device 700 may be or may include for example a workstation or personal computer or may be at least partially implemented by one or more remote servers (e.g., in the “cloud”).

Operating system 715 may be or may include any code segment designed and/or configured to perform tasks involving coordination, scheduling, arbitration, supervising, controlling or otherwise managing operation of computing device 700, for example. Operating system 715 may be a commercial operating system. Operating system 715 may be or may include any code segment designed and/or configured to provide a virtual machine, e.g., an emulation of a computer system. Memory 720 may be or may include, for example, a random-access memory (RAM), a read only memory (ROM), a dynamic RAM (DRAM), a synchronous DRAM (SD-RAM), a double data rate (DDR) memory chip, a Flash memory, a volatile memory, a non-volatile storage, a cache memory, a buffer, a short-term memory unit, a long-term memory unit, or other suitable memory units or storage units. Memory 720 may be or may include a plurality of possibly different memory units.

Executable code 725 may be any executable code, e.g., an application, a program, a process, task or script. Executable code 725 may be executed by processor 705 possibly under control of operating system 715. For example, executable code 725 may be or include software for generating a mathematical representation of a dataset and for finding enrichments for datasets, according to embodiments of the invention.

Storage 730 may be or may include, for example, a hard disk drive, a non-volatile storage, a flash memory, a floppy disk drive, a Compact Disk (CD) drive, a CD-Recordable (CD-R) drive, a universal serial bus (USB) device or other suitable removable and/or fixed storage unit. Storage 730 may store datasets 732, e.g., candidate datasets and new datasets, as well as other data required for performing embodiments of the invention, such as embeddings 734 of datasets, and data related to NN such as NN 232 and 234.

In some embodiments, some of the components shown in FIG. 8 are omitted. For example, memory 720 may be a non-volatile storage having the storage capacity of storage 730. Accordingly, although shown as a separate component, storage 730 may include memory 720.

Input devices 735 may be or may include a mouse, a keyboard, a touch screen or pad or any suitable input device. It will be recognized that any suitable number of input devices may be operatively connected to computing device 700 as shown by block 735. Output devices 740 may include one or more displays, speakers and/or any other suitable output devices. It will be recognized that any suitable number of output devices may be operatively connected to computing device 700 as shown by block 740. Any applicable input/output (I/O) devices may be connected to computing device 700 as shown by blocks 735 and 740. For example, a wired or wireless network interface card (NIC), a modem, printer or facsimile machine, a universal serial bus (USB) device or external hard drive may be included in input devices 735 and/or output devices 740. Network interface 750 may enable computing device 700 to communicate with one or more other computers or networks. For example, network interface 750 may include a Wi-Fi or Bluetooth device or connection, a connection to an intranet or the internet, an antenna etc.

Embodiments described in this disclosure may include the use of a special purpose or general-purpose computer including various computer hardware or software modules, as discussed in greater detail below.

Embodiments within the scope of this disclosure also include computer-readable media, or non-transitory computer storage medium, for carrying or having computer-executable instructions or data structures stored thereon. The instructions when executed may cause the processor to carry out embodiments of the invention. Such computer-readable media, or computer storage medium, can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general-purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computer” may be any computing system as previously defined herein, or any module or combination of modulates running on a computing system.

For the processes and/or methods disclosed, the functions performed in the processes and methods may be implemented in differing order as may be indicated by context. Furthermore, the outlined steps and operations are only provided as examples, and some of the steps and operations may be optional, combined into fewer steps and operations, or expanded into additional steps and operations.

The present disclosure is not to be limited in terms of the particular embodiments described in this application, which are intended as illustrations of various aspects. Many modifications and variations can be made without departing from its scope. Functionally equivalent methods and apparatuses within the scope of the disclosure, in addition to those enumerated, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used in this disclosure is for the purpose of describing particular embodiments only, and is not intended to be limiting.

This disclosure may sometimes illustrate different components contained within, or connected with, different other components. Such depicted architectures are merely exemplary, and many other architectures can be implemented which achieve the same or similar functionality.

Aspects of the present disclosure may be embodied in other forms without departing from its spirit or essential characteristics. The described aspects are to be considered in all respects illustrative and not restrictive. The claimed subject matter is indicated by the appended claims rather than by the foregoing description. All changes which come within the meaning and range of equivalency of the claims are to be embraced within their scope.

1. A method for finding data enrichments for a first dataset, the method comprising, using a processor:
obtaining a plurality of candidate datasets;
calculating a plurality of mathematical representations, each for one of the first dataset and one of the plurality of candidate datasets, wherein calculating the mathematical representation of a dataset of the first dataset and the plurality of candidate datasets comprises:
calculating a set of features of the dataset; and
feeding the set of features of the dataset to a first neural network trained to generate the mathematical representation;
calculating a plurality of similarity levels, each indicative of the similarity between the mathematical representation of one of the plurality of candidate datasets and the mathematical representation of the first dataset; and
selecting the candidate dataset based on the similarity levels.

2. The method of claim 1, wherein calculating the set of features for each dataset comprises:
calculating column interaction features, wherein the column interaction features are features related to interactions between different columns of data from the plurality of columns of data;
calculating features related to statistics of a column of data from the plurality of columns of data; and
predicting an ontology of a column of data from the plurality of columns of data.

3. The method of claim 2, wherein generating column interaction features for a pair of columns of data comprises:
inferring pairs of data items from different columns using a second neural network to generate inferred values; and
providing the inferred values into a pooling layer.

4. The method of claim 1, wherein training the first neural network comprises:
using labeled pairs of sets of features to train a Siamese neural network, wherein a label of a pair indicates whether the two sets of features in the pair pertain to a same dataset.

5. The method of claim 4, comprising generating the labeled pairs of sets of features by:
obtaining a first labeled pair of datasets;
selecting a subset of each dataset of the pair of datasets to generate a second labeled pair of datasets; and
calculating the set of features for each dataset of the second pair of datasets.

6. The method of claim 1, comprising updating a current mathematical representation of a first candidate dataset of at least one of the plurality of candidate datasets by:
obtaining new data pertaining to the first candidate dataset;
generating a new mathematical representation for the new data; and
combining the new mathematical representation with the current mathematical representation.

7. The method of claim 6, wherein combining the new mathematical representation with the current mathematical representation is performed using weighted average with an exponential decay factor.

8. The method of claim 1, comprising using the selected candidate dataset to enrich the first dataset, wherein enriching the first dataset with the selected candidate dataset comprises combining the first dataset with the selected candidate dataset.

9. The method of claim 1, wherein each of the first dataset and the candidate datasets comprises a time series.

10. The method of claim 1, wherein calculating the level of similarity between the first dataset and a candidate dataset comprises one of:
calculating Euclidean distance between the mathematical representation of the first dataset and the mathematical representation of the candidate dataset,
calculating cosine similarity between the mathematical representation of the first dataset and the mathematical representation of the candidate dataset, or
training a second machine learning model to calculate the level of similarity using labeled pairs of mathematical representations and feeding the mathematical representations of the first dataset and the mathematical representation of the candidate dataset to the trained second machine learning model to calculate the level of similarity.

11. A system for finding data enrichments for a first dataset, the system comprising:
a memory;
a processor configured to:
obtain a plurality of candidate datasets;
calculate a plurality of mathematical representations, each for one of the first dataset and one of the plurality of candidate datasets, wherein calculating the mathematical representation of a dataset of the first dataset and the plurality of candidate datasets comprises:
calculating a set of features of the dataset; and
feeding the set of features of the dataset to a first neural network trained to generate the mathematical representation;
calculate a plurality of similarity levels, each indicative of the similarity between the mathematical representation of one of the plurality of candidate datasets and the mathematical representation of the first dataset; and
select the candidate dataset based on the similarity levels.

12. The system of claim 11, wherein the processor is configured to calculate the set of features for each dataset by:
calculating column interaction features, wherein the column interaction features are features related to interactions between different columns of data from the plurality of columns of data;
calculating features related to statistics of a column of data from the plurality of columns of data; and
predicting an ontology of a column of data from the plurality of columns of data.

13. The system of claim 12, wherein the processor is configured to generate column interaction features for a pair of columns of data by:
inferring pairs of data items from different columns using a second neural network to generate inferred values; and
providing the inferred values into a pooling layer.

14. The system of claim 11, wherein the processor is configured to train the first neural network by:
using labeled pairs of sets of features to train a Siamese neural network, wherein a label of a pair indicates whether the two sets of features in the pair pertain to a same dataset.

15. The system of claim 14, wherein the processor is configured to generate the labeled pairs of sets of features by:
obtaining a first labeled pair of datasets;
selecting a subset of each dataset of the pair of datasets to generate a second labeled pair of datasets; and
calculating the set of features for each dataset of the second pair of datasets.

16. The system of claim 11, wherein the processor is configured to update a current mathematical representation of a first candidate dataset of at least one of the plurality of candidate datasets by:
obtaining new data pertaining to the first candidate dataset;
generating a new mathematical representation for the new data; and
combining the new mathematical representation with the current mathematical representation.

17. The system of claim 16, wherein the processor is configured to combine the new mathematical representation with the current mathematical representation using weighted average with an exponential decay factor.

18. The system of claim 11, wherein the processor is configured to use the selected candidate dataset to enrich the first dataset, wherein enriching the first dataset with the selected candidate dataset comprises combining the first dataset with the selected candidate dataset.

19. The system of claim 11, wherein each of the first dataset and the candidate datasets comprises a time series.

20. The system of claim 11, wherein the processor is configured to calculate the level of similarity between the first dataset and a candidate dataset by one of:
calculating Euclidean distance between the mathematical representation of the first dataset and the mathematical representation of the candidate dataset,
calculating cosine similarity between the mathematical representation of the first dataset and the mathematical representation of the candidate dataset, or
training a second machine learning model to calculate the level of similarity using labeled pairs of mathematical representations and feeding the mathematical representations of the first dataset and the mathematical representation of the candidate dataset to the trained second machine learning model to calculate the level of similarity.
